(19) United States
(12) Patent Application Publication
(10) Pub. No.: US 2020/0158546 A1
(43) Pub. Date: May 21, 2020

(54) SENSOR FOR DETECTING AT LEAST ONE PROPERTY OF A FLUID MEDIUM

(71) Applicant: Robert Bosch GmbH, Stuttgart (DE)

(72) Inventor: Michael Rittmann, Ditzingen (DE)

(21) Appl. No.: 16/604,004

(22) PCT Filed: Mar. 27, 2018
(86) PCT No.: PCT/EP2018/057782

§ 371 Date: Oct. 9, 2019

(30) Foreign Application Priority Data
Apr. 11, 2017 (DE) 10 2017 206 226.6

(51) Int. Cl. G01F 1/684; G01F 15/02; G01K 13/02; G01K 7/16; G01K 1/16

(52) U.S. Cl. CPC G01F 1/684; G01F 15/022; G01K 2013/024; G01K 7/16; G01K 1/16; G01K 13/02

(57) ABSTRACT

A sensor for detecting at least one property of a fluid medium is provided. The sensor includes at least one sensor element as well as at least one circuit substrate including at least one control and evaluation circuit. The circuit substrate (112) has at least one projection. At least one temperature sensor is fixed in place on the projection.

### BACKGROUND INFORMATION

Different sensors for detecting at least one property of a fluid medium are available in the related art. More specifically, the fluid medium may involve a gas such as air, and the sensors may be used in an intake and/or exhaust gas tract of an internal combustion engine, in particular. Other application field are also possible, however.

For example, German Patent Application DE 10 2013 224 831 A1 describes a sensor system for determining at least one flow characteristic of a streaming fluid medium. The sensor system includes at least one sensor for determining the flow characteristic. The sensor has at least one hot-wire measuring element, the hot-wire measuring element having at least one carrier element. The sensor system is developed so that the carrier element projects into the fluid medium. The carrier element has at least one recess. The recess is spanned by at least one hot wire.

Without restricting additional possible embodiments, the present invention will be described in the following text with reference to what is generally known as hot-film air-mass meters as they are described in, for example, Robert Bosch GmbH: Sensoren im Kraftfahrzeug [Sensors in the Motor Vehicle], Konrad Reif (Publ.), 2^{nd} edition, pages 146-148. However, other developments are basically possible as well.

In such hot-film air-mass meters, a sensor chip is usually glued to a sensor substrate and the sensor substrate together with a base plate of a control and evaluation circuit forms a unit. In addition, the control and evaluation circuit is bonded to the base plate. An evaluation IC (ASIC) in which a measuring value acquisition, conditioning and the output of the measured values may take place is usually located on the circuit board.

However, a basic technical challenge with conventional sensors of the above-mentioned type is that apart from the actual measured value of the sensor element, a temperature normally has to be acquired as a marginal condition in addition because flow characteristics, in particular, may be temperature-dependent. What is known as NTC temperature sensors, i.e. temperature sensors on a semiconductor basis with a negative temperature coefficient, for instance, are able to be used for this purpose. However, a particular technical challenge in this context is the electrical coupling of the temperature sensor with the control and evaluation circuit without causing thermal coupling between the temperature sensor and the control and evaluation circuit, which falsifies the temperature measurement of the temperature sensor on account of waste heat of the control and evaluation circuit.

### SUMMARY

An example sensor for detecting at least one property of a fluid medium is provided. The property may basically be any physical and/or chemical property. In particular, the property may be a flow characteristic, e.g., a mass flow and/or a volumetric flow of the fluid medium.

The sensor includes at least one sensor element as well as at least one circuit substrate having at least one control and evaluation circuit. A sensor element generally describes an element, in particular a monolithic element, which is able to detect at least one measured variable. In particular, the sensor element may have at least one sensor chip. Within the framework of the present invention, a circuit substrate may generally be understood as a device which is able to support at least one electrical circuit. In particular, the circuit substrate may be developed in the form of a plate, preferably as a circuit board. Accordingly, for instance, the circuit substrate may be developed as a planar circuit board, e.g., made from a fiber-reinforced plastic and/or a ceramic material. Other developments are basically possible as well, however. A control and evaluation circuit within the framework of the present invention is generally to be understood as an electronic circuit which has at least one electrical or electronic component and is developed to control at least one sensor function of the sensor element and/or to receive at least one measuring signal from the sensor element and to evaluate or condition it completely and/or partially. More specifically, the control and evaluation circuit may have at least one integrated switching circuit (IC), preferably at least one application-specific integrated switching circuit (ASIC).

The circuit substrate has at least one projection, and at least one temperature sensor is fixed in place on the projection. The temperature sensor may particularly include at least one temperature-sensitive resistor, preferably a resistor having a negative temperature coefficient (NTC). A projection generally describes an area of the circuit substrate which projects from an otherwise planar surface of the circuit substrate or from an otherwise straight edge of the circuit substrate. In particular, the projection may extend in a plane of the circuit substrate. For example, the circuit substrate may essentially have a planar development, and the projection extends in the plane of the circuit substrate. The projection may project from the circuit substrate by 2 mm to 20 mm, and in particular by 2 mm to 10 mm, for example.

The sensor may particularly include a sensor housing. In general, a sensor housing is to be understood as an element or a device which essentially seals the sensor from the outside and/or which lends mechanical stability to the sensor. The sensor housing in particular may be fully or partially made of plastic and/or a metallic material.

In particular, the sensor housing may have at least one flow channel. A flow channel is generally to be understood as a channel or a channel section which is formed within the housing and through which the fluid medium is able to flow. For instance, the housing may have at least one inlet and at least one outlet, the inlet and outlet being connected by the flow channel. In particular, the sensor may be developed as a plug-in probe, which is able to be inserted into a fluid medium, e.g., into a flow tube of the fluid medium. In this constellation, the fluid medium may then flow from the flow tube into the flow channel and flow through it. In particular, the sensor may be developed in such a way that the sensor element is situated on a sensor substrate that projects into the flow channel. The circuit substrate may particularly be situated outside the flow channel in an electronics space of the housing. For example, as described above, the circuit substrate may be applied on a base such as a base plate, which is situated in the electronics space. The circuit substrate may be fixedly connected to the base, for instance. In addition, the sensor element on the sensor substrate is able to be connected to the circuit substrate, e.g., with the aid of wire bonding or also other connection techniques.

The temperature sensor may particularly be developed as an SMD component. More specifically, the temperature sensor is able to be developed as a resistor featuring a negative temperature coefficient (NTC), e.g., as an NTC in an SMD configuration.

In particular, the sensor element may include at least one sensor chip and/or be completely or partially developed as a sensor chip. The sensor element may particularly have at least one measuring surface including at least one heating element situated on the measuring surface and at least two temperature probes situated on the measuring surface. Accordingly, the sensor chip may be a hot-film air-mass meter sensor chip in which an asymmetry produced by the air mass flow in a temperature profile generated by the heating element is detected with the aid of the two temperature probes. As mentioned earlier, the sensor may be developed as a plug-in probe, in particular. More specifically, the sensor may be developed as a hot-film air-mass meter. The temperature sensor is particularly able to be electrically connected to the control and evaluation circuit. The control and evaluation circuit may particularly be developed to consider at least one temperature signal of the temperature sensor in an evaluation of at least one signal from the sensor element. For example, the control and evaluation circuit may be developed to carry out at least one temperature correction in at least one signal of the sensor element.

The circuit substrate is especially able to be developed as a circuit board. The projection may be developed as a circuit board web, in particular, which projects from the circuit substrate. More specifically, the circuit board may have an essentially rectangular development, and the projection projects from the circuit board at one corner of the circuit board.

With the aid of the projection on the circuit substrate on which the temperature sensor is fixed in place, the temperature sensor is able to be completely or partially thermally decoupled from the at least one control and evaluation circuit, which will be described in greater detail in the following text. In addition, further measures for a temperature control and/or for the thermal decoupling are able to be provided. For example, the circuit substrate may especially also include at least one cooling element. More specifically, the cooling element may be placed in the area of the temperature sensor, e.g., at a distance of no more than 20 mm, preferably no more than 10 mm, from the temperature sensor. The cooling element may include at least one cooling fin, for example.

As described earlier, the control and evaluation circuit may especially include at least one integrated switching circuit, in particular at least one ASIC. For the further decoupling between the integrated switching circuit, which generates waste heat generally, and the temperature sensor, additional thermal decoupling measures are able to be provided between the temperature sensor and the integrated switching circuit. More specifically, at least one milled cut for the thermal decoupling of the temperature sensor from the integrated switching circuit is able to be introduced into the circuit substrate between the temperature sensor and the integrated switching circuit. For instance, at least one slot and/or at least one groove may be cut into an upper side and/or an underside of the circuit board so that at least one milled web, in particular, may be produced.

In contrast to known sensors of the mentioned type, the sensor according to the present invention offers a great number of advantages. In particular, the described measures make it possible to produce excellent thermal decoupling between the temperature sensor and possible heat sources in the control and evaluation circuit. This generally allows for the most precise temperature measurement possible and for a short response time. More specifically, the present invention makes it easily possible to decouple a temperature sensor in the form of an NTC represented in a SMD configuration from the rest of the circuit board, the temperature sensor being mounted on circuit board electronics of a hot-film air-mass meter. Intrinsic heat effects of the hot-film air-mass meter electronics are able to be minimized in this manner. As a whole, the present invention thus makes it possible to achieve a greater measuring accuracy and a short response time during abrupt changes in temperature. Due to the use of an NTC in an SMD configuration on the circuit board of a hot-film air-mass meter, a temperature sensor is able to be connected to the evaluation circuit in a cost-effective manner.

The use of a temperature sensor, in particular an NTC in an SMD configuration, is generally more cost-effective than the use of a wired NTC. Moreover, because the temperature sensor is integrated into the control and evaluation circuit, the sensor housing is able to have a cost-effective design since no separate space for the temperature sensor has to be provided in the sensor housing and no separate linkage of the temperature sensor to the control and evaluation circuit has to be established, e.g., using an expensive welding method. In particular, it is possible to dispense with a conductor comb for connecting the temperature sensor to the control and evaluation circuit.

Furthermore, the production costs may generally be reduced because the temperature sensor is able to be mounted on the circuit substrate using conventional methods and, for example, simultaneously with other electronic components. In an advantageous manner, for instance, the component fitting and a reflow soldering method of an SMD-NTC component may be employed instead of a complex batch production. In the case of conventional hot-film air-mass meters, intrinsic heating of the circuit board may reach up to 15K depending on the variant. Because of the described measures for the thermal decoupling, heating effects at the location of the temperature sensor, e.g., the NTC, are able to be reduced and the measuring accuracy and dynamics of the sensor may therefore be increased.

The temperature sensor, e.g., the NTC, is easily able to be mounted on a narrow circuit board web. This web, for instance, may be connected to the rest of the circuit board only via a small area and consequently be largely decoupled from the remaining circuit board. In addition to the thermal decoupling of the temperature sensor, existing or arising heat in the region of the temperature sensor is able to be dissipated with the aid of additional cooling fins, e.g., a single cooling fin or multiple cooling fins.

### BRIEF DESCRIPTION OF THE DRAWINGS

Additional details and optional features of the present invention result from the description below of preferred exemplary embodiments, which are shown in the figures.

FIG. 1 shows an exploded view of a possible exemplary embodiment of a sensor according to the present invention for detecting at least one property of a fluid medium.

FIGS. 2A and 2B show two possible exemplary embodiments of circuit substrates to be used in a sensor according to the present invention, in a perspective illustration.

### DETAILED DESCRIPTION OF EXAMPLE EMBODIMENTS

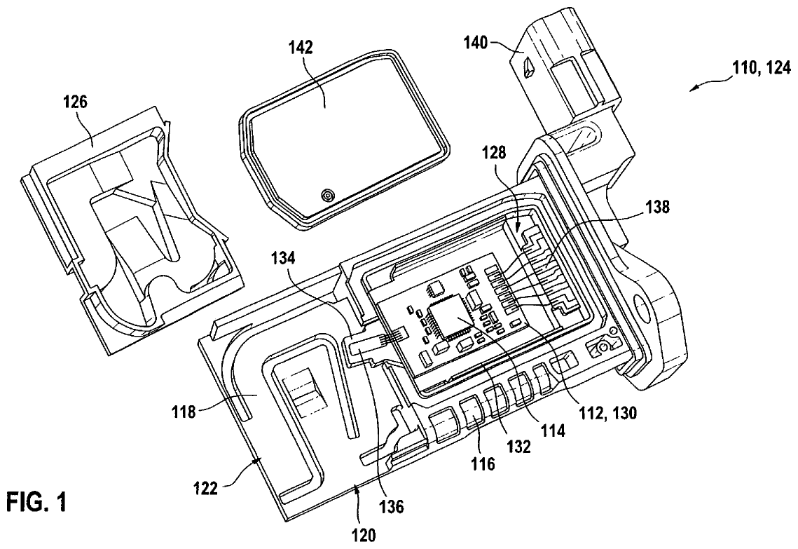

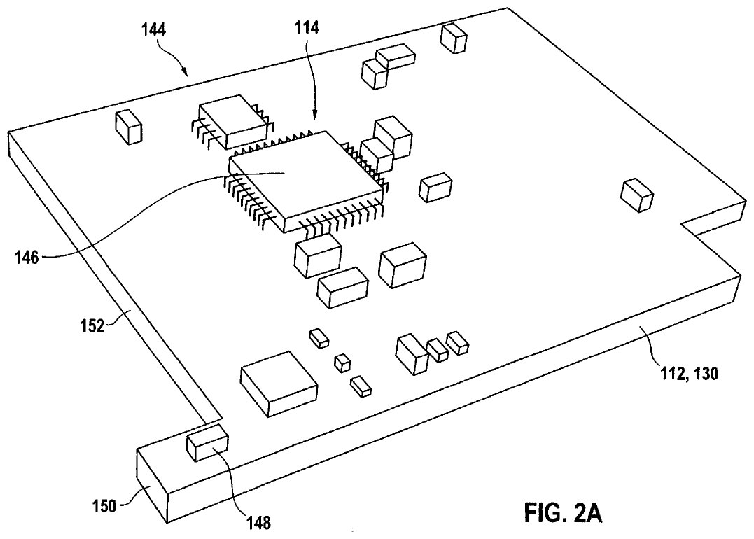

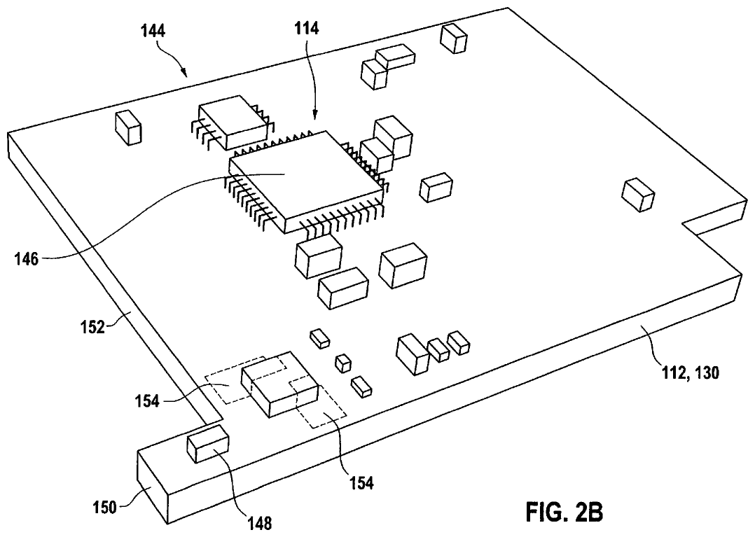

FIG. 1 shows an exemplary embodiment of a sensor 110 for detecting at least one property of a fluid medium 110 according to the present invention. The following FIGS. 2A and 2B show circuit substrates 112 that include a control and evaluation circuit 114, which may be used in sensor 110 according to FIG. 1, for example. These figures are jointly described below.

In the exemplary embodiment shown in FIG. 1, sensor 110 includes a sensor housing 116 provided with a flow channel 118. Fluid medium is able to enter flow channel 118 through an inlet opening 120, also referred to an inlet, then stream through flow channel 118 and subsequently leave it again through a discharge opening 122, also referred to as an outlet. Sensor 110 as a whole may particularly be developed as a plug-in probe 124 and, for instance, be plugged into a flow tube through which the fluid medium passes. For example, inlet opening 120 points counter to the flow of the fluid medium. Flow channel 118 is able to be sealed by a flow channel cover 126, for example.

In addition, an electronics space 128 is developed inside sensor housing 116, which accommodates a circuit substrate 112 which includes a control and evaluation circuit 114 situated thereon. Circuit substrate 112 is developed as a circuit board 130, for example, which is glued to a base such as a base plate 132. Connected to base plate 132 is a sensor substrate 134, for instance made of plastic, which projects from electronics space 128 into flow channel 118 in the form of a winglet, for instance. Fixed in place on sensor substrate 134 is a sensor element 136, which is able to be developed in the form of a hot-film air-mass meter sensor chip, for instance. It may have a measuring surface, for example, across which the fluid medium in flow channel 118 is able to flow, the measuring surface having at least one heating element as well as at least two temperature probes, which are disposed in symmetry with respect to the heating element, for example. Sensor element 136 may be connected to circuit board 130 with the aid of wire bonds, for instance.

For example, circuit substrate 112 is able to be connected to a plug 140 by a conductor comb 138, via which the electrical contacting of sensor 110 may be carried out. During the operation, electronics space 128 may furthermore be sealed by an electronics space cover 142.

In FIG. 2A, a first possible development of circuit substrate 112 including control and evaluation circuit 114 is shown in a perspective view. It can be gathered that circuit substrate 112, which, for example, may be developed as an essentially rectangular circuit board 130 in this case, may be fitted with a plurality of electronics components 144. In particular, at least one integrated switching circuit 146 may be provided, preferably at least one application-specific integrated switching circuit (ASIC). These electronics components 144 and integrated switching circuit 146, in particular, may produce waste heat.

In addition, sensor 110 has at least one temperature sensor 148, which may be developed as an SMD-NTC, for instance. However, this temperature sensor is not integrated into sensor housing 116 at a random location and connected to control and evaluation circuit 114 in a complex and costly manner but instead is directly mounted on circuit substrate 112. In order to nevertheless ensure thermal decoupling between temperature sensor 148 and the rest of control and evaluation circuit 114 to which temperature sensor 148 may be electrically connected, circuit substrate 112 is provided with a projection 150. This projection 150 may project from circuit board 130 at an edge 152, for instance. Temperature sensor 148, for example, may be fixed in place on this projection 150, e.g., using SMD technology, in which case projection 150 may be developed as a narrow circuit board web, for instance. This small circuit board web is preferably connected to circuit board 130 via only a small area and thereby largely thermally decoupled from it.

FIG. 2B shows another exemplary embodiment of circuit substrate 112, which represents a further development of the exemplary embodiment according to FIG. 2A. This example illustrates that additional features and measures may be taken for the thermal decoupling of temperature sensor 148 from control and evaluation circuit 114. In addition to the development of circuit substrate 112 including projection 150, for instance in the form of a circuit board web and/or in the form of the circuit board tab, one or a plurality of cooling fins (not shown) may be provided, for example. Alternatively or additionally, milled cuts 154 may be introduced into circuit board 130, which can be used for an additional thermal decoupling of temperature sensor 148 from integrated switching circuit 146.

1-11. (canceled)

12. A sensor for detecting at least one property of a fluid medium, comprising:
at least one sensor element;
at least one circuit substrate having at least one control and evaluation circuit, wherein the circuit substrate has at least one projection; and
at least one temperature sensor fixed in place on the projection.

13. The sensor as recited in claim 12, wherein the sensor has a sensor housing including a flow channel, the sensor element being fixed in place on a sensor substrate that projects into the flow channel, and the circuit substrate is situated outside the flow channel in an electronics space of the sensor housing.

14. The sensor as recited in claim 12, wherein the temperature sensor is an SMD component.

15. The sensor as recited in claim 12, wherein the temperature sensor is an NTC.

16. The sensor as recited in claim 12, wherein the sensor is a hot-film air-mass meter.

17. The sensor as recited in claim 12, wherein the temperature sensor is electrically connected to the control and evaluation circuit, and the control and evaluation circuit is configured o consider at least one temperature signal of the temperature sensor in an evaluation of at least one signal of the sensor element.

18. The sensor as recited in claim 12, wherein the circuit substrate is a circuit board.

19. The sensor as recited in claim 12, wherein the projection is a circuit board web.

20. The sensor as recited in claim 12, wherein the circuit board is rectangular, and the projection projects from the circuit board at one corner of the circuit board.

21. The sensor as recited in claim 12, wherein the circuit substrate includes at least one cooling element.

22. The sensor as recited in claim 12, wherein the control and evaluation circuit includes at least one integrated switching circuit, and at least one milled cut for a thermal decoupling of the temperature sensor from the integrated switching circuit is in the circuit substrate between the temperature sensor and the integrated switching circuit.
